(19) United States
(12) Patent Application Publication
(10) Pub. No.: US 2023/0265234 A1
(43) Pub. Date: Aug. 24, 2023

(54) LOW DENSITY THERMOSETTING FOAMS HAVING IMPROVED PROPERTIES

(71) Applicant: HONEYWELL INTERNATIONAL INC., Chalotte, NC (US)

(72) Inventors: Josep Gimeno, Charlotte, NC (US); Tripti Srivastava, Gurgaon (IN); Heng Huang, Shanghai (CN); Mary Bogdan, Charlotte, NC (US); Yiu Keung Ling, Charlotte, NC (US); An-Hung Yeh, Charlotte, NC (US); Bruce Weinheimer, Charlotte, NC (US)

(73) Assignee: HONEYWELL INTERNATIONAL INC., Charlotte, NC (US)

(21) Appl. No.: 18/096,703

(22) Filed: Jan. 13, 2023

Related U.S. Application Data
(60) Provisional application No. 63/299,379, filed on Jan. 13, 2022.

(51) Int. Cl. C08G 18/42; C08G 18/82; C08G 18/08; C08J 9/14

(52) U.S. Cl. CPC C08G 18/42; C08G 18/82; C08G 18/14; C08J 9/144; C08J 2205/052; C08J 2375/06

(57) ABSTRACT

Disclosed are methods of forming foam comprising: (a) providing a foamable composition comprising an isocyanate, a polyol and a physical blowing agent comprising at least about 50% by weight of trans1233zd and wherein the polyol comprises a polyol or mixture of polyols such that the trans1233zd(E) has a solubility in said polyol of 20 pphp or less and (b) forming a foam from said foamable composition.

### CROSS REFERENCE TO RELATED APPLICATION

The present invention claims the priority benefit of U.S. Provisional 63/299,379, filed Jan. 13, 2022, which is incorporated herein by reference in its entirety.

### FIELD

The present invention relates to thermoset foams, in particular polyurethane foam, a polyisocyanurate foam or a mixture thereof, which achieve improved thermal insulating properties, and to foamable compositions and foaming methods for making same.

### BACKGROUND

The use of foam to provide thermal insulation is well known. For example, insulation boards made from polyisocyanurate (PIR) or polyurethane (PU) foams have been used in commercial, residential and industrial buildings to provide resistance to the flow of heat in and/or out of the buildings. Other forms of PU and PIR foams have also been used at least in part for their thermal insulating value.

Polyurethane foams are typically produced by reacting a polyisocyanate (usually a di- or trisiocyanate) with one or more polyols in the presence of one or more blowing agents, one or more catalysts, one or more surfactants and optionally other ingredients. In the case of PIR foam, the foam is formed by the reaction of polyisocyanate with itself to form a cyclic trimer structure. In practice, foams commonly described as polyisocyanurate (also referred to PIR) contain both polyurethane and polyisocyanurate structures and foams described as polyurethane often incorporate some polyisocyanurate structures. Thus, the present application relates to polyurethane foams, to polyisocyanurate foams and to mixtures thereof. The blowing agent can be a physical blowing agent or a chemical blowing agent. Physical blowing agents create bubbles in the liquid mixture by volatilizing and expanding due to the heat generated when the polyisocyanurate reacts with the polyol, forming bubbles therein. In the case of chemical blowing agents, also known as gas generating materials, gaseous species are generated by thermal decomposition or reaction with one or more of the ingredients used to produce the polyurethane and/or polyisocyanurate foam. As the polymerization reaction proceeds, the liquid mixture becomes a cellular solid, entrapping the blowing agent in the cells of the foam.

It has been common to use certain liquid fluorocarbon blowing agents as blowing agents because of their ease of use, among other factors. Fluorocarbons not only act as physical blowing agents by virtue of their volatility, but also are encapsulated or entrained in the closed cell structure of the foam and are generally the major contributor to the thermal conductivity properties of the foams. After the foam is formed, the k-factor or lambda associated with the foam produced provides a measure of the ability of the foam to resist the transfer of heat through the foam. A foam having a lower k-factor is more resistant to heat transfer and therefore generally a better foam for thermal insulation purposes. Thus, the production of lower k-factor foams is generally desirable and advantageous.

In recent years, concern over climate change has driven the development of a new generation of blowing agents which are able to meet the requirements of both ozone depletion and climate change regulations. One hydrohaloolefin of particular interest is trans1-chloro-3,3,3-trifluoropropene (1233zd(E)). See, for example, U.S. Pat. No. 8,420,706, which assigned to assignee of the present invention. Processes for the manufacture of trans-1-chloro-3,3,3-trifluoropropene are disclosed, for example, in U.S. Pat. Nos. 6,844,475 and 6,403,847.

The desirability of a thermal insulating foam will generally depend upon several properties of the foam as formed, including the density of the foam and the thermal insulating ability of the foam. While the initial value of these properties at about the time the board is formed is given consideration, a more important consideration is frequently the value these properties after the foam will have, or will be expected to have, over an extended period of time. This is because a PIR or PU foam, for example in the form of an insulation board, may be present as part of a building for a long period of time, at it is considered critically important in many applications that the foam will be expected to provide desirable insulating and density properties over a substantial period of use.

Estimates of the average thermal conductivity (lambda value or k-factor) over a period of 25 years of use under operational conditions can be made using European standard EN13165:2012+A2:2016 (2010) for factory made rigid polyurethane and polyisocyanurate foam products used as thermal insulation boards for buildings and European Standard EN14315 (2013) for in-situ formed sprayed rigid polyurethane and polyisocyanurate foam products (both of which are incorporated by reference). This K-factor value (sometimes referred to as aged K-factor) that a foam achieves is frequently considered an important measure of the performance and value of the foam. The blowing agent 1233zd(E) is generally known to provide desirably low aged K-factor values for PU and PIR foams.

The density of the foam after a period of ageing is also considered important for many applications. In particular, it is known to test the ability of a foam, at a given density, to resist dimensional change upon ageing. According to this testing protocol, a foam at an initial density is subject to an accelerated ageing test conditions and the dimensional change in the foam in is measured. One such test is referred to as the “Dim-Vac” test as conducted as described in the Examples hereof. According to this test, if the change in volume is a large negative number (i.e., −5% or a larger negative number), then test is considered to predict an unacceptable catastrophic failure of the foam during the expected use lifetime of the foam, and the density of the foam which produces this result is considered to be below the minimum useful density.

Applicants have come to appreciate that while rigid PU and PIR foam that has heretofore been formed using 1233zd(E) blowing agent has achieved excellent thermal conductivity, they have also had a minimum useful density that is undesirably high, which in turn presents an unsolved problem with the use of 1233zd(E) as a blowing agent for rigid PU and PIR thermal insulating foam.

### SUMMARY

The present invention includes methods of producing thermosetting PU and/or PIR foams with good thermal insulating properties (including preferably low initial, low aged lambda and/or low delta lambda values) and low usable minimum density, said method comprising:

(a) providing a polyol premix composition comprising a blowing agent comprising at least about 50% by weight of trans-1-chloro-3,3,3-trifluoropropene (1233zd(E)) and one or more polyol components that together have a sufficiently low solubility limit for said 1233zd(E) to permit foams made from said premix to have a minimum usable density (hereinafter referred sometimes referred to as “MUD”) of less than 27 kg/m³; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 1A.

The terms “1233zd(E) solubility” and minimum usable density (or MUD) are determined as measured in accordance with the procedures identified in the Examples hereof or by a procedure that would provide essentially the same measure +/−2 relative percent.

As used herein with respect to percent by weight of a component, “about” means the indicated weight percentage+/−2 relative percent.

As used herein, the term “pphp” means parts by weight per hundred weight parts of polyol.

The present invention also includes methods of producing thermosetting PU and/or PIR foams with good thermal insulating properties (including preferably low initial, low aged lambda and/or low delta lambda values) and low usable minimum density, said method comprising:

(a) providing a polyol premix composition comprising a blowing agent comprising at least about 50% by weight of trans-1-chloro-3,3,3-trifluoropropene (1233zd(E)) and one or more polyol components that together have a sufficiently low solubility limit for said blowing agent to permit foams made from said premix to have a MUD of less than 27 kg/m³; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 1B.

The present invention also includes methods of producing thermosetting PU and/or PIR foams with good thermal insulating properties (including preferably low initial, low aged lambda and/or low delta lambda values) and low usable minimum density, said method comprising:

(a) providing a polyol premix composition comprising one or more polyols and a blowing agent comprising trans-1-chloro-3,3,3-trifluoropropene (1233zd(E)), wherein said one or more polyols comprises at least about 50% by weight of a polyol having a 1233zd(E) solubility of about 20 pphp or less; and

(b) combining said polyol premix composition with a polyisocyanate to form a foamable composition; and

(c) foaming said foamable composition and producing a foam having a minimum usable density (hereinafter referred sometimes referred to as “MUD”) of less than 27 kg/m³. For the purposes of convenience, methods in accordance with this paragraph are referred to herein as Method 1C.

The present invention also includes methods of producing thermosetting PU and/or PIR foams with good thermal insulating properties (including preferably low initial, low aged lambda and/or low delta lambda values) and low usable minimum density, said method comprising:

(a) providing a polyol premix composition comprising one or more polyols and a blowing agent comprising trans-1-chloro-3,3,3-trifluoropropene (1233zd(E)), wherein said one or more polyols comprises at least about 50% by weight of polyol(s) having a 1233zd(E) solubility of about 20 pphp or less; and

(b) combining said polyol premix composition with a polyisocyanate to form a foamable composition; and

(c) foaming said foamable composition and producing a foam having a minimum usable density (hereinafter referred sometimes referred to as “MUD”) of less than 27 kg/m³, an initial K-factor of less than about 18 mW/mK, and a Delta lambda of less than 6. For the purposes of convenience, methods in accordance with this paragraph are referred to herein as Method 1D.

The present invention also includes methods of producing thermosetting PU and/or PIR foams with good thermal insulating properties (including preferably low initial, low aged lambda and/or low delta lambda values) and low usable minimum density, said method comprising:

(a) providing a polyol premix composition comprising one or more polyols and a blowing agent comprising trans-1-chloro-3,3,3-trifluoropropene (1233zd(E)), wherein said one or more polyols comprises at least about 50% by weight of polyol(s) having a 1233zd(E) solubility of less than about 15 pphp; and

(b) combining said polyol premix composition with a polyisocyanate to form a foamable composition; and

(c) foaming said foamable composition and producing a foam having a minimum usable density (hereinafter referred sometimes referred to as “MUD”) of less than 27 kg/m³, an initial K-factor of less than about 18 mW/mK, and a Delta lambda of less than 6. For the purposes of convenience, methods in accordance with this paragraph are referred to herein as Method 1E.

The present invention also includes methods of producing thermosetting PU and/or PIR foams with good thermal insulating properties (including preferably low initial, low aged lambda and/or low delta lambda values) and low minimum usable density, said method comprising:

(a) providing a polyol premix composition comprising one or more polyols and a blowing agent comprising trans-1-chloro-3,3,3-trifluoropropene (1233zd(E)), wherein said one or more polyols comprises at least about 75% by weight of a polyol having a 1233zd(E) solubility of about 20 pphp or less; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 2A.

The present invention also includes methods of producing thermosetting PU and/or PIR foams with good thermal insulating properties (including preferably low initial, low aged lambda and/or low delta lambda values) and low minimum usable density, said method comprising:

(a) providing a polyol premix composition comprising one or more polyols and a blowing agent comprising trans-1-chloro-3,3,3-trifluoropropene (1233zd(E)), wherein said one or more polyols comprises at least about 75% by weight of a polyol having a 1233zd(E) solubility of about 15 pphp or less; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 2B.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols comprises at least about 75% by weight of a polyol having a 1233zd(E) solubility of less than about 14 pphp; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 3.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols comprises at least about 80% by weight of a polyol having a 1233zd(E) solubility of about 20 pphp or less; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 4A.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols comprises at least about 80% by weight of a polyol having a 1233zd(E) solubility of about 15 pphp or less; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 4B.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols comprises at least about 85% by weight of a polyol having a 1233zd(E) solubility of less than about 14 pphp; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 5.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols comprises at least about 90% by weight of a polyol having a 1233zd(E) solubility of about 20 or less; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 6A.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols comprises at least about 90% by weight of a polyol having a 1233zd(E) solubility of about 15 pphp or less; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 6B.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols consist essentially of polyol(s) having a 1233zd(E) solubility of about 20 pphp or less; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 7A.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols consist essentially of polyol(s) having a 1233zd(E) solubility of about 15 pphp or less; and

(b) combining said polyol premix composition with a polyisocyanate to form a foamable composition; and

(c) foaming said foamable composition and producing a foam having a MUD of less than 27 kg/m³, an initial K-factor of less than about 18 mW/mK, and a Delta lambda of less than 6. For the purposes of convenience, methods in accordance with this paragraph are referred to herein as Method 7B.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols consist essentially of polyol(s) having a 1233zd(E) solubility of less than about 15 pphp; and

(b) combining said polyol premix composition with a polyisocyanate to form a foamable composition; and

(c) foaming said foamable composition and producing a foam having a MUD of less than 27 kg/m³. For the purposes of convenience, methods in accordance with this paragraph are referred to herein as Method 7C.

The present invention also includes methods of producing thermosetting PU and/or PIR foams with good thermal insulating properties (including preferably low initial, low aged lambda and/or low delta lambda values) and low minimum density, said method comprising:

(a) providing a polyol premix composition comprising one or more polyols and a blowing agent comprising trans-1-chloro-3,3,3-trifluoropropene (1233zd(E)), wherein said one or more polyols consist essentially of polyol(s) having a 1233zd(E) solubility of less than about 15 pphp; and

(b) combining said polyol premix composition with a polyisocyanate to form a foamable composition; and

(c) foaming said foamable composition and producing a foam having a MUD of less than 27 kg/m³, an initial K-factor of less than about 18 mW/mK, and a Delta lambda of less than 6. For the purposes of convenience, methods in accordance with this paragraph are referred to herein as Method 7D.

The present invention also includes methods of producing thermosetting PU and/or PIR foams with good thermal insulating properties (including preferably low initial, low aged lambda and/or low delta lambda values) and low usable minimum density, said method comprising:

(a) providing a polyol premix composition comprising one or more polyols and a physical blowing agent, said physical blowing agent comprising greater than 60% by weight of trans-1-chloro-3,3,3-trifluoropropene (1233zd(E)) and less than 40% by weight of cyclopentane based on the total weight of the physical blowing agent, wherein said one or more polyols comprises at least about 50% by weight of a polyol having a 1233zd(E) solubility of 20 pphp or less; and

(b) combining said polyol premix composition with a polyisocyanate to form a foamable composition; and

(c) foaming said foamable composition to produce a foam to produce a foam having delta lambda of less than 4.5 mW/m K. For the purposes of convenience, methods in accordance with this paragraph are referred to herein as Method 8A.

The present invention also includes methods of producing thermosetting PU and/or PIR foams with good thermal insulating properties (including preferably low initial, low aged lambda and/or low delta lambda values) and low usable minimum density, said method comprising:

(a) providing a polyol premix composition comprising one or more polyols and a physical blowing agent, said blowing agent comprising at least about 70% by weight of trans-1-chloro-3,3,3-trifluoropropene (1233zd(E)) and less than about 30% by weight of cyclopentane based on the total weight of the physical blowing agent, wherein said one or more polyols comprises at least about 50% by weight of a polyol having a 1233zd(E) solubility of about 20 pphp or less; and

(b) combining said polyol premix composition with a polyisocyanate to form a foamable composition; and

(c) foaming said foamable composition to produce a thermal insulating foam. For the purposes of convenience, methods in accordance with this paragraph are referred to herein as Method 8B.

The present invention also includes methods of producing thermosetting PU and/or PIR foams with good thermal insulating properties (including preferably low initial, low aged lambda and/or low delta lambda values) and low usable minimum density, said method comprising:

(a) providing a polyol premix composition comprising one or more polyols and a physical blowing agent, said blowing agent consisting essentially of at about 70% or greater by weight of trans-1-chloro-3,3,3-trifluoropropene (1233zd(E)) and about 30% or less by weight of cyclopentane based on the total weight of the physical blowing agent, wherein said one or more polyols comprises at least about 50% by weight of a polyol having a 1233zd(E) solubility of about 20 pphp or less; and

(b) combining said polyol premix composition with a polyisocyanate to form a foamable composition; and

(c) foaming said foamable composition and producing a thermal insulating foam.

For the purposes of convenience, methods in accordance with this paragraph are referred to herein as Method 8C.

The present invention includes thermosetting PU and/or PIR foams with good thermal insulating properties (including preferably low initial, low aged lambda and/or low delta lambda values) and low minimum density, said foams comprising:

(a) a plurality of closed cells comprising cell walls formed of PU and/or PIR; and

(b) 1233zd(E) contained in said closed cells, wherein said foam has a minimum usable density (hereinafter referred to as “MUD”) of less than 27 kg/m³. For the purposes of convenience, methods in accordance with this paragraph are referred to herein as Foam 1.

The present invention includes thermosetting PU and/or PIR foams with good thermal insulating properties (including preferably low initial, low aged lambda and/or low delta lambda values) and low minimum density, said foams comprising:

(a) cell walls formed of PU and/or PIR forming a plurality of closed cells; and

(b) 1233zd(E) contained in said sell walls, wherein said foam has a MUD of less than 27 kg/m³ and an initial K-factor of less than about 18 mW/mK. For the purposes of convenience, methods in accordance with this paragraph are referred to herein as Foam 2A.

The present invention includes thermosetting PU and/or PIR foams with good thermal insulating properties (including preferably low initial, low aged lambda and/or low delta lambda values) and low minimum density, said foams comprising:

(c) cell walls formed of PU and/or PIR forming a plurality of closed cells; and

(d) 1233zd(E) contained in said sell walls, wherein said foam has a MUD of less than 27 kg/m³, an initial K-factor of less than about 18 mW/mK, and a Delta lambda of less than 6. For the purposes of convenience, methods in accordance with this paragraph are referred to herein as Foam 2B.

The present invention includes thermosetting PU and/or PIR foams with good thermal insulating properties (including preferably low initial, low aged lambda and/or low delta lambda values) and low minimum density, said foams comprising:

(a) cell walls formed of PU and/or PIR forming a plurality of closed cells; and

(b) 1233zd(E) contained in said sell walls, wherein said foam has a MUD of less than 26 kg/m³, an initial K-factor of less than about 18 mW/mK and a Delta lambda of less than 6. For the purposes of convenience, methods in accordance with this paragraph are referred to herein as Foam 3.

The present invention includes thermosetting PU and/or PIR foams with good thermal insulating properties (including preferably low initial, low aged lambda and/or low delta lambda values) and low minimum density, said foams comprising:

(a) cell walls formed of PU and/or PIR forming a plurality of closed cells; and

(b) 1233zd(E) contained in said sell walls, wherein said foam has a MUD of about 25 kg/m³ or less, an initial K-factor of less than about 18 mW/mK, and a Delta lambda of less than 6. For the purposes of convenience, methods in accordance with this paragraph are referred to herein as Foam 4.

The present invention includes thermosetting PU and/or PIR foams with good thermal insulating properties (including preferably low initial, low aged lambda and/or low delta lambda values) and low minimum usable density, said foams comprising:

(a) cell walls formed of PU and/or PIR forming a plurality of closed cells; and

(b) 1233zd(E) contained in said sell walls, wherein said foam has a MUD of less than 25 kg/m³, an initial K-factor of less than about 18 mW/mK, and Delta lambda of less than 6. For the purposes of convenience, methods in accordance with this paragraph are referred to herein as Foam 5.

The present invention includes thermosetting PU and/or PIR foams with good thermal insulating properties (including preferably low initial, low aged lambda and/or low delta lambda values) and low minimum density, said foams comprising:

(a) a plurality of closed cells comprising cell walls formed of PU and/or PIR; and

(b) 1233zd(E) contained in said sell walls,

wherein said foam has a MUD of about 24 kg/m³ or less and wherein said foam has an initial K-factor of less than about 18 mW/mK and a Delta lambda of less than 6. For the purposes of convenience, methods in accordance with this paragraph are referred to herein as Foam 6.

### BRIEF DESCRIPTION OF THE DRAWINGS

FIG. 1 is a chart showing the MUD for Polyol A as determined in Comparative Example 1.

FIG. 2A is a chart showing the MUD for Polyol D using 1233zd(E) as the blowing agent and as determined in Comparative Example 2.

FIG. 2B is a chart showing the MUD for Polyol D using a combination of 1233zd(E) and cyclopentane as the blowing agent and as determined in Comparative Example 2.

FIG. 3 is a chart showing the MUD for Polyol B as determined in Example 1.

FIG. 4 is a chart showing the MUD for Polyol C as determined in Example 2.

FIG. 5A is a chart showing the MUD for Polyol E using 1233zd(E) as the blowing agent and as determined in Example 3.

FIG. 5B is a chart showing the MUD for Polyol E using a combination of 1233zd(E) and cyclopentane as the blowing agent and as determined in Example 4.

FIG. 6 is a chart showing the results from Example 5.

### DEFINITIONS

trans1233zd and 1233zd(E) each means trans1-chloro-3,3,3-trifluoropropene.
Closed cell foam means that a substantial volume percentage of the cells in the foam are closed, for example, about 20% by volume or more.
Initial K-factor (also sometimes referred to as Initial Lambda) means initial thermal conductivity measured in compliance with EN 13165:2012+A2:2016, which is accordingly measured at a reference mean temperature of 10° C.
Aged K-factor (also sometimes referred to as Aged Lambda) means aged thermal conductivity measured in compliance with EN 13165:2012+A2:2016, which is accordingly measured at a reference mean temperature of 10° C.
Delta lambda means the value as measured in accordance with the procedure in the examples hereof.
Density means foam density as measured in the examples.
Minimum Useable Density and MUD each mean the minimum usable density measured as in the examples.

### DETAILED DESCRIPTION

### Foamable Compositions

As mentioned above, the foamable compositions of the present invention include as essential components thermosetting material (preferably urethanes and/or isocyanurates), polyols and physical blowing agent. Other than as described as being required herein, the specific properties and amounts of these components may be provided over those broad ranges known to those skilled in the art, and additional optional components, including those described below, can also be included with such broad ranges.

### Blowing Agent

For the purposes of this invention, the physical blowing agent preferably comprises at least about 50% by weight of trans-1-chloro-3,3,3-trifluoropropene (1233zd(E)). For the purposes of convenience, blowing agent in accordance with this paragraph are referred to herein as Blowing Agent 1.

For the purposes of this invention, the physical blowing agent preferably comprises greater than 60% by weight of trans-1-chloro-3,3,3-trifluoropropene (1233zd(E)). For the purposes of convenience, blowing agent in accordance with this paragraph are referred to herein as Blowing Agent 2.

For the purposes of this invention, the physical blowing agent preferably comprises at least about 70% by weight of trans-1-chloro-3,3,3-trifluoropropene (1233zd(E)). For the purposes of convenience, blowing agent in accordance with this paragraph are referred to herein as Blowing Agent 3.

For the purposes of this invention, the physical blowing agent preferably comprises greater than 60% by weight of trans-1-chloro-3,3,3-trifluoropropene (1233zd(E)) and less than 40% by weight of cyclopentane based on the total weight of the physical blowing agent. For the purposes of convenience, blowing agent in accordance with this paragraph are referred to herein as Blowing Agent 4.

For the purposes of this invention, the physical blowing agent preferably comprises at least about 70% by weight of trans-1-chloro-3,3,3-trifluoropropene (1233zd(E)) and not greater than about 30% by weight of cyclopentane based on the total weight of the physical blowing agent. For the purposes of convenience, blowing agent in accordance with this paragraph are referred to herein as Blowing Agent 5.

A preferred embodiment which achieves excellent thermal insulating results, including particularly initial lambda, aged lambda and delta lambda, at a low cost comprises a physical blowing agent that from greater than 60% to about 70% by weight of trans-1-chloro-3,3,3-trifluoropropene (1233zd(E)) and about 30% to less than 40% by weight of cyclopentane based on the total weight of the physical blowing agent. For the purposes of convenience, blowing agent in accordance with this paragraph are referred to herein as Blowing Agent 6.

Optional co-blowing agents include 1,3,3,3-tetrafluoropropene (1234ze) and 1,1,1,4,4,4-hexafluorobut-2-ene (1336mzzm). 1,3,3,3-Tetrafluoropropene (1234ze) can be provided as the cis isomer, the trans isomer or a combination thereof. Preferably, 1,3,3,3-tetrafluoropropene is provided as the trans isomer. 1,1,1,4,4,4-Hexafluorobut-2-ene (1336mzzm) can be provided as the cis isomer, the trans isomer or a combination thereof. Preferably, 1,1,1,4,4,4-hexafluorobut-2-ene is provided as the cis isomer.

The physical blowing agent used in accordance with the methods of the present invention, including each of Methods 1-25, may comprise, consist essentially of, or consist of trans-1-chloro-3,3,3-trifluoropropene (1233zd).

In each of Methods 1-7, the blowing agent may comprise Blowing Agent 1, or Blowing Agent 2, or Blowing Agent 3, or Blowing Agent 4 or Blowing Agent 5 or Blowing Agent 6.

The blowing agent may additionally comprise one or more additional co-blowing agents, such as a hydrocarbon, fluorocarbon, chlorocarbon, fluorochlorocarbon, hydrochlorofluorocarbon, hydrofluorocarbon, halogenated hydrocarbon, ether, fluorinated ether, ester, acetal, alcohol, aldehyde, ketone, organic acid, gas generating material, water, carbon dioxide (CO₂), or combinations thereof. Preferred blowing agents have a Global Warming Potential (GWP) of not greater than 150, more preferably not greater than 100 and even more preferably not greater than 75. As used herein, “GWP” is measured relative to that of carbon dioxide and over a 100-year time horizon, as defined in “The Scientific Assessment of Ozone Depletion, 2002, a report of the World Meteorological Association's Global Ozone Research and Monitoring Project,” which is incorporated herein by reference. Preferred blowing agents have an Ozone Depletion Potential (ODP) of not greater than 0.05, more preferably not greater than 0.02 and even more preferably about zero. As used herein, “ODP” is as defined in “The Scientific Assessment of Ozone Depletion, 2002, A report of the World Meteorological Association's Global Ozone Research and Monitoring Project,” which is incorporated herein by reference.

Preferred optional chemical co-blowing agents include water, organic acids that produce CO₂ and/or CO.

Preferred optional physical co-blowing agents include CO₂, ethers, halogenated ethers; esters, alcohols, aldehydes, ketones; trans-1,2 dichloroethylene; methylal, methyl formate; hydrofluorocarbons, such as 1,1,1,2-tetrafluoroethane (134a); 1,1,2,2-tetrafluoroethane (134); 1,1,1,3,3-pentafluorobutane (365mfc); 1,1,1,2,3,3,3-heptafluoropropane (227ea), 1,1,1,3,3,3-hexafluoropropane (236fa); 1,1,1,2,3,3-hexafluoropropane (236ea); 1,1,1,2,3,3,3-heptafluoropropane (227ea), 1,1-difluoroethane (152a); 1,1,1,3,3-pentafluoropropane (245fa); hydrocarbons such as butane; isobutane; normal pentane; isopentane; cyclopentane, or combinations thereof.

More preferably, the co-blowing agents are one or more selected from water, organic acids that produce CO₂ and/or CO, trans-1,2 dichloroethylene; methylal, methyl formate; 1,1,1,2-tetrafluoroethane (134a); 1,1,1,3,3-pentafluorobutane (365mfc); 1,1,1,2,3,3,3-heptafluoropropane (227ea), 1,1-difluoroethane (152a); 1,1,1,3,3-pentafluoropropane (245fa); butane; isobutane; normal pentane; isopentane; cyclopentane, or combinations thereof.

The blowing agent of the present invention, including each of Blowing Agents 1-6, that is, trans1233zd and any optionally co-blowing agent, is preferably present in foamable composition in an amount of from about 1 wt. % to about 30 wt. %, preferably from about 3 wt. % to about 25 wt. %, and more preferably from about 5 wt. % to about 25 wt. %, by weight of the polyol plus blowing agent in the composition.

### Polyols

As mentioned above, applicants have found that careful selection of the polyols used in the foamable compositions of the present can have an unexpected but highly beneficial effect on the heat transfer resistance of the foam, including relatively low MUD values. Accordingly, the polyol according to the present invention should be selected to be in accordance with one of the structural requirements set forth herein (e.g., a solubility for 1233zd(E) of about 20 pphp or less). Provided one of these selections is made as per the teachings hereof, the polyol can be any polyol or polyol mixture which reacts in a known fashion with an isocyanate in preparing a polyurethane foam, a polyisocyanurate foam or a mixture thereof. Preferred polyols are polyester polyols, and even more preferably polyester polyols that include aromatic groups in the polyol. Other useful polyols, in addition to the preferred polyester polyols, optionally can include for example sucrose containing polyol; phenol, a phenol formaldehyde containing polyol; a glucose containing polyol; a sorbitol containing polyol; a methyl glucoside containing polyol.

The polyol or mixture of polyols can be present in the foamable composition in an amount, for example of from about 20 wt. % to about 70 wt. %, preferably from about 30 wt. % to about 60 wt. %, and more preferably from about 35 wt. % to about 55 wt. %, based on the total weight of the foamable composition.

The polyol, and preferably the polyester polyol and even more preferably aromatic polyester polyol, can preferably have one or more of the following properties within the following broad, medium and narrow ranges, and any combination of these properties and ranges:

| | | | |
|---|---|---|---|
| | Broad | Medium | Narrow |
| Functionality | 1 -4 | 1 -3 | 1.5-2.5 |
| Hydroxyl Number, | 100-400 | 100-350 | 150-300 |
| mg KOH/g | | | |
| Acid Number | 0.1 -3.0 | 0.3-2.8 | >0.5-2.5 |
| mg KOH/g (max) | | | |
| Viscosity @ 25C, | 2000 - 6000 | 2500 - 5500 | 2500 - 5000 |
| Cp | | | |

Commercially available low solubility polyols that may be used in connection with the present invention include those available from Stepan, Coim and Puranova.

### Isocyanate

For the purposes of this invention, the isocyanate can be any organic polyisocyanate which can be employed in polyurethane and/or polyisocyanurate foam synthesis inclusive of aliphatic and aromatic polyisocyanates. Suitable organic polyisocyanates include aliphatic, cycloaliphatic, araliphatic, aromatic, and heterocyclic isocyanates which are well known in the field of polyurethane chemistry. These are described in, for example, U.S. Pat. Nos. 4,868,224; 3,401,190; 3,454,606; 3,277,138; 3,492,330; 3,001,973; 3,394,164; 3,124.605; and 3,201,372, which are incorporated herein by reference. Preferred as a class are the aromatic polyisocyanates.

Representative organic polyisocyanates correspond to the formula:

R(NCO)_{z}

wherein R is a polyvalent organic radical which is either aliphatic, aralkyl, aromatic or mixtures thereof, and z is an integer which corresponds to the valence of R and is at least two. Representative of the organic polyisocyanates contemplated herein includes, for example, the aromatic diisocyanates such as 2,4-toluene diisocyanate, 2,6-toluene diisocyanate, mixtures of 2,4- and 2,6-toluene diisocyanate, crude toluene diisocyanate, methylene diphenyl diisocyanate, crude methylene diphenyl diisocyanate; the aromatic triisocyanates such as 4,4′,4″-triphenylmethane triisocyanate, 2,4,6-toluene triisocyanates; the aromatic tetraisocyanates such as 4,4′-dimethyldiphenylmethane-2,2′5,5-′tetraisocyanate; arylalkyl polyisocyanates such as xylylene diisocyanate; aliphatic polyisocyanate such as hexamethylene-1,6-diisocyanate, lysine diisocyanate methylester; and mixtures thereof. Other organic polyisocyanates include polymethylene polyphenylisocyanate, hydrogenated methylene diphenylisocyanate, m-phenylene diisocyanate, naphthylene-1,5-diisocyanate, 1-methoxyphenylene-2,4-diisocyanate, 4,4′-biphenylene diisocyanate, 3,3′-dimethoxy-4,4′-biphenyl diisocyanate, 3,3′-dimethyl-4,4′-biphenyl diisocyanate, and 3,3′-dimethyldiphenylmethane-4,4′-diisocyanate; Typical aliphatic polyisocyanates are alkylene diisocyanates such as trimethylene diisocyanate, tetramethylene diisocyanate, and hexamethylene diisocyanate, isophorene diisocyanate, and 4, 4′-methylenebis(cyclohexyl isocyanate), and the like; typical aromatic polyisocyanates include m-, and p-phenylene disocyanate, polymethylene polyphenyl isocyanate, 2,4- and 2,6-toluenediisocyanate, dianisidine diisocyanate, bitoylene isocyanate, naphthylene 1,4-diisocyanate, bis(4-isocyanatophenyl)methene, bis(2-methyl-4-isocyanatophenyl)methane. Preferred polyisocyanates are the polymethylene polyphenyl isocyanates, Particularly the mixtures containing from about 30 to about 85 percent by weight of methylenebis(phenyl isocyanate) with the remainder of the mixture comprising the polymethylene polyphenyl polyisocyanates of functionality higher than 2. These polyisocyanates are prepared by conventional methods known in the art. In the present invention, the polyisocyanate and the polyol are preferably employed in amounts which will yield an NCO/OH stoichiometric ratio in a range of from about 0.9 to about 5.0. In the present invention, the NCO/OH equivalent ratio is, preferably, about 1 or more and about 4 or less, with the ideal range being from about 1.1 to about 3. Especially suitable organic polyisocyanate include polymethylene polyphenyl isocyanate, methylenebis(phenyl isocyanate), toluene diisocyanates, or combinations thereof.

### Other Components

Other components that can be included in the foamable composition include silicone surfactant, a non-silicone surfactant, and catalyst (including metal catalyst and an amine catalyst and combinations thereof.

Non-Silicon Surfactants

A non-silicone surfactant, such as a non-silicone, non-ionic surfactant, may include oxyethylated alkylphenols, oxyethylated fatty alcohols, paraffin oils, castor oil esters, ricinoleic acid esters, turkey red oil, groundnut oil, paraffins, and fatty alcohols. A preferred non-silicone non-ionic surfactant is LK-443 which is commercially available from Air Products Corporation or Vorasurf 504 from DOW.

When a non-silicone, non-ionic surfactant used, it is usually present in the composition in an amount of from about 0.25 wt. % to about 3.0 wt. %, preferably from about 0.5 wt. % to about 2.5 wt. %, and more preferably from about 0.75 wt. % to about 2.0 wt. %, by weight based on the weight of polyol, the blowing agent and the silicon in the composition.

Catalysts

Catalysts can include amine catalysts and/or metal catalysts. Amine catalysts may include, but are not limited to, primary amine, secondary amine or tertiary amine. Useful tertiary amine catalysts non-exclusively include N,N-dimethylcyclohexylamine, N,N-dimethylethanolamine, dimethylaminoethoxyethanol, N,N,N′-trimethylaminoethyl-ethanolamine, N,N,N′-trimethyl-N′-hydroxyethylbisaminoethylether, tetramethyliminobispropylamine, 2-[[2-[2-(dimethylamino)ethoxy]ethyl] methylamino] ethanol, pentamethyldiethylene-triamine, pentamethyldipropylenetriamine, N,N,N′,N″,N″-pentamethyl-dipropylenetriamine, 1,1,4,7,10,10-hexamethyltriethylenetetram ine, N,N-bis(3-dimethylaminopropyl)-N-isopropanolamine, N′-(3-(dimethylamino) propyl)-N,N-dimethyl-1,3-propanediamine, bis(3-dimethylaminopropyl)-n, n-dimethylpropanediamine, bis-(2-dimethylaminoethyl)ether, N,N′,N″-dimethylaminopropylhexahydrotriazine, tetramethyliminobispropylamine, trimethyl-n′,2-hydroxyethyl-propylenediamine, Bis-(3-aminopropyl)-methylamine, N,N-dimethyl-1,3-propanediamine, 1-(dimethylamino)hexadecane, benzyldimethylamine, 3-dimethylam inopropyl urea, dicyclohexylmethylamine; ethyldiisopropylamine; dimethylisopropylamine; methylisopropylbenzylamine; methylcyclopentylbenzylamine; isopropyl-sec-butyl-trifluoroethylamine; diethyl-(α-phenylethyl)amine, tri-n-propylamine, or combinations thereof. Useful secondary amine catalysts non-exclusively include dicyclohexylamine; t-butylisopropylamine; di-t-butylamine; cyclohexyl-t-butylamine; di-sec-butylamine, dicyclopentylamine; di-(α-trifluoromethylethyl)amine; di-(α-phenylethyl)amine; or combinations thereof.

Other useful amines include morpholines, imidazoles and ether containing compounds. These include:
dimorpholinodiethylether
N-ethylmorpholine
N-methylmorpholine
bis(dimethylaminoethyl) ether
imidizole
n-methylimidazole
1,2-dimethylimidazole
dimorpholinodimethylether
N,N,N′,N′,N″,N″-pentamethyldiethylenetriamine
N,N,N′,N′,N″,N″-pentaethyldiethylenetriamine
N,N,N′,N′,N″,N″-pentamethyldipropylenetriamine
bis(diethylaminoethyl) ether
bis(dimethylaminopropyl) ether.

Suitable non-amine catalysts may comprise an organometallic compound containing bismuth, lead, tin, titanium, antimony, uranium, cadmium, cobalt, thorium, aluminium, mercury, zinc, nickel, cerium, molybdenum, vanadium, copper, manganese, zirconium, sodium, potassium, lithium, magnesium, barium, calcium, hafnium, lanthanum, niobium, tantalum, tellunum, tungsten, cesium, or combinations thereof. Preferably, the non-amine catalyst comprises an organometallic compound containing bismuth, lead, tin, zinc, sodium, potassium or combinations thereof.

The non-amine catalysts includes, bismuth 2-ethylhexonate, lead 2-ethylhexonate, lead benzoate, stannous salts of carboxylic acids, zinc salts of carboxylic acids, dialkyl tin salts of carboxylic acids (e.g., dibutyltin dilaurate, dimethyltin dineodecanoate, dioctyltin dineodecanoate, dibutyltin dilaurylmercaptide dibutyltin diisooctylmaleate dimethyltin dilaurylmercaptide dioctyltin dilaurylmercaptide, dibutyltin dithioglycolate, dioctyltin dithioglycolate), potassium acetate, potassium octoate, potassium 2-ethylhexoate, glycine salts, quaternary ammonium carboxylates, alkali metal carboxylic acid salts and tin (II) 2-ethylhexanoate or combinations thereof.

Trimerization catalysts can be used for the purpose of converting the blends in conjunction with excess isocyanate to polyisocyanurate-polyurethane foams. The trimerization catalysts employed can be any catalyst known to one skilled in the art, including, but not limited to, glycine salts, tertiary amine trimerization catalysts, quaternary ammonium carboxylates, and alkali metal carboxylic acid salts and mixtures of the various types of catalysts. Preferred trimerization catalysts are potassium acetate, potassium octoate, and N-(2-hydroxy-5-nonylphenol)methyl-N-methylglycinate.

Flame Retardants

Flame retardants are added to foam insulation boards to inhibit or delay the spread of fire by suppressing the chemical reactions in the flame or by forming a protective char layer on the surface of a material. Generally, flame retardants are added to the polyol premix or foamable composition as a liquid or solid. The flame retardants can alternatively be added with the isocyanurate or can be added as a separate stream prior to forming the foam. Generally, flame retardants can be mineral based, organohalogen compounds or organophosphorus compounds. Conventional flame retardants used in foam insulation boards include tris(2-chloroethyl)phosphate, tris(2-chloropropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl) am inomethylphosphonate, dimethyl methylphosphonate, tri(1,3-dichloropropyl)phosphate, and tetra-kis-(2-chloroethyl)ethylene diphosphate, triethylphosphate, ammonium phosphate, various halogenated aromatic compounds, aluminum trihydrate, diethyl-N, N-bis (2-hydroxyethyl) aminomethylphosphonate (Fyrol 6) and melamine.

For the purposes of this invention, the phosphate based flame retardants are preferably selected from the group consisting of tris(2-chloroethyl)phosphate, tris(2-chloropropyl)phosphate, tris(1,3-dichloropropyl)phosphate, tri(2-chloroisopropyl)phosphate, tricresyl phosphate, tri(2,2-dichloroisopropyl)phosphate, diethyl N,N-bis(2-hydroxyethyl) am inomethylphosphonate, dimethyl methylphosphonate, tri(1,3-dichloropropyl)phosphate, diethyl-N, N-bis (2-hydroxyethyl) aminomethylphosphonate (Fyrol 6) tetra-kis-(2-chloroethyl)ethylene diphosphate, triethylphosphate and ammonium phosphate, more preferably tris(1-chloro-2-propyl) phosphate (TCPP), triethylphosphate (TEP) and diethyl-N, N-bis (2-hydroxyethyl) aminomethylphosphonate (Fyrol 6).

The amount of the phosphate-based flame retardant in the polyol premix composition is preferably 25 phpp or less, preferably 20 phpp or less, preferably 15 pphp or less, preferably 10 pphp or less, preferably 5 pphp or less. Preferably, the foamable composition does not contain a phosphate-based flame retardant.

The flame retardants can be blended with the polyols and therefore provided in the polyol premix composition with the polyol or mixture of polyols, prior to the production of the foamable composition. Alternatively, the flame retardants can be added as a separate stream during the formation of the foamable composition. For the purposes of this invention, the amount of phosphate-based flame retardant includes all phosphate-based flame retardant, i.e., the amount of phosphate based flame retardant present in the polyol premix composition or added as a separate stream during the formation of the foamable composition.

Others

In addition, other ingredients such as, dyes, fillers, pigments and the like can be included in the polyol premix composition. Dispersing agents and cell stabilizers can used. Conventional fillers for use herein include, for example, aluminum silicate, calcium silicate, magnesium silicate, calcium carbonate, barium sulfate, calcium sulfate, glass fibers, carbon black and silica. The filler, if used, is normally present in an amount by weight ranging from about 5 parts to 100 parts per 100 parts of polyol. A pigment which can be used herein can be any conventional pigment such as titanium dioxide, zinc oxide, iron oxide, antimony oxide, chrome green, chrome yellow, iron blue siennas, molybdate oranges and organic pigments such as para reds, benzidine yellow, toluidine red, toners and phthalocyanines.

### Foaming Methods

The preparation of polyurethane and/or polyisocyanurate foams using the blowing agent, polyol, optional other components and an isocyanate may follow any of the methods well known in the art for forming foams, see Saunders and Frisch, Volumes I and II Polyurethanes Chemistry and Technology, 1962, John Wiley and Sons, New York, N.Y. or Gum, Reese, Ulrich, Reaction Polymers, 1992, Oxford University Press, New York, N.Y. or Klempner and Sendijarevic, Polymeric Foams and Foam Technology, 2004, Hanser Gardner Publications, Cincinnati, Ohio, all of which are incorporated herein by reference. In general, polyurethane and/or polyisocyanurate foams are prepared by combining inter alia an isocyanate and a polyol premix composition. The produced foams are preferably closed cell foams which can be rigid or semi-rigid. Preferably the produced foams are rigid foams.

For the purposes of this invention, the isocyanate can be provided in combination with other components, such as certain silicone surfactants. The isocyanate can be combined with the blowing agent, but it is envisaged in this application, that the blowing agent will at least primarily comprise the polyol premix composition of the first aspect. The invention does however encompass the option wherein at least a portion of the blowing agent is combined with the isocyanate.

The polyurethane foam, polyisocyanurate foam or mixtures thereof are prepared by bringing together the isocyanate and polyol premix composition either by hand mix for small preparations and, preferably, machine mix continuous or discontinuous production techniques to form boards, blocks, slabs, laminates, pour-in-place panels and other items, spray applied foams, froths, and the like. Optionally, other ingredients such as colorants, auxiliary blowing agents, water, catalysts, and even other polyols can be added as a stream to the mix head or reaction site. Most conveniently, however, they are all, incorporated into the polyol premix composition as described above.

For the purposes of this invention, the polyurethane foam, polyisocyanurate foam or mixtures thereof are produced as continuous or discontinuous pour in place panels, boards or spray applied foams.

In particular, when the foam is provided as a board or a panel, the foam can be produced by pouring the foamable mixture between two facings of a panel, allowing the foam to rise to produce a “foam sandwich” which is cut to the desired length. The facings of the panel can be aluminum foil, roofing paper, metal, wood, etc. The resulting boards or panels can then be applied to an existing building envelope or used to form a building envelope. These panels can be produced by continuous or by a discontinuous process, or by a combination of these.

### Uses

Among many uses, the foams of the present invention may be used to insulate buildings (e.g., building envelope) or any construction where energy management and/or insulation from temperature fluctuations on its exterior side are desirable. Such structures include any standard structure known in the art including, but not limited to those, manufactured from clay, wood, stone, metals, plastics, concrete, or the like, including, but not limited to homes, office buildings, or other structures residential, commercial, industrial, agricultural, or otherwise where energy efficiency and insulation may be desirable.

Thus, an aspect of the invention relates to a board foam, a foam core panel or a spray foam produced by the method of the first aspect of the invention.

### Experimental Procedure

Polyol blend: Blends were prepared by mixing the materials based on formulations below.
Foaming: The foam was made by hand mixing based on the formulations listed below. A mold (30 cm*30 cm*10 cm) was used.
Lambda value: The lambda value was recorded using the Laser Comp FOX50 with a sample size of 20 cm×20 cm×2 cm.

In the case of the examples hereof, the four polyols tested are designated as Polyol A, Polyol B, Polyol C, Polyol D and Polyol E. These polyols have the following properties:

| | | | | | |
|---|---|---|---|---|---|
| | Polyol A | Polyol B | Polyol C | Polyol D | Polyol E |
| Chemical | Aromatic | Diethylene | Aromatic | Aromatic | Aromatic |
| Description | Polyester | glycol-phthalic | polyester | polyester | polyester |
| | Polyol | anhydride | polyol | polyol | polyol |
| | | polymer (CAS | | | |
| | | 32472-85-8)at | | | |
| | | 60-85% in 10- | | | |
| | | <20% | | | |
| | | diethylene | | | |
| | | glycol | | | |
| Molecular | 468 | 430 | Approx. 450 | ND | ND |
| Weight (avg) | | | | | |
| Functionality | 2.0 | 2.0 | 2.0 | 2.0 | 2.0 |
| Hydroxyl | 230-250 | 260 | 235 | 235-255 | 230-250 |
| Number, mg | | | | | |
| KOH/g | | | | | |
| acid Number, | 0.6-1.0 | 0.5-1.2 | 0.5-1.2 | 1.5-2.5 | 0.6-1.0 |
| mg KOH/g | | | | | |
| (max) | | | | | |
| Viscosity @ | 3000 | 4400 | 4000 | 3000-4500 | 3000-4500 |
| 25C, cp | | | | | |
| Density @ | 9.9 | 10.3 | ND | 10.1 | 10.3 |
| 25C, 1 b./US gal | | | | | |
| Equivalent | 234 | ND | ND | ND | ND |
| Weight (avg) | | | | | |

ND - not determined

### Example #1—1233zd(E) Solubility in Polyols

The five polyols identified above were tested for the ability to solvate 1233zd(E) at various concentrations including one or more of 10, 15 and 20 parts by weight per hundred parts of polyol (pphp). The test was conducted by forming a mixture containing the indicated amount of 1233zd(E) blowing agent and the balance of polyol in a calibrated miscibility tube. The mixtures were thoroughly mixed at room temperature, and then the tube was placed in a constant temperature bath at room temperature for about 24 hours. If only a single phase is observed after this period, the solubility limit of the blowing agent is indicated as being greater than tested amount. If two phases were clearly observed, then the solubility limit of the blowing agent is indicated as being less than the amount tested. The results are tabulated below:

| Ployol» | Polyol | Polyol | Polyol | Polyol D | | | Polyol E | | |
|---|---|---|---|---|---|---|---|---|---|
| | A | B | C | | | | | | |
| Blowing | 15 | 15 | 15 | 10 | 15 | 20 | 10 | 15 | 20 |
| Agent | | | | | | | | | |
| Amount | | | | | | | | | |
| (pphp) | | | | | | | | | |
| Solubility | FS | TPF | TPF | FS | FS | FS | FS | FS | NSL |
| Result* | | | | | | | | | |

*- FS indicates fully solvated; TPF indicates two phases were formed; NSL means that a
single-phase murky mixture is observed, indicating that the concentration is at or
essentially at the solubility limit for the purposes of the present invention.

The tests showed that Polyol A fully solvated the 15 pphp of 1233zd(E), and therefore had a 1233zd(E) solubility limit that is greater than 15 pphp and believed to be greater than 20 pphp, but that for each of Polyol B, Polyol C and Polyol D reached the solubility limit at 20 pphp or less, and in particular less than 15 pphp for Polyols B and C. For the Polyol D, 1233zd(E) was fully solvated at all concentrations tested, and thus the solubility limit of this polyol is greater than 20 pphp.

### Comparative Examples 1-2: MUD for High Solubility Polyols in PIR Foam

A series of foams were prepared using two high solubility polyols (Polyol A and Polyol D) as the polyol component of the foamable composition as described in Table C1 below:

TABLE C1A

| Component | Parts by weight |
|---|---|
| Polyol | 100 |
| Foam stabilizer (L5162) | 2.0 |
| Catalysts | |
| Dabco K15 | 1.6 |
| Polycat 8 | 0.5 |
| Polycat 5 | 0.3 |
| Flame retardant (yx%62mqwt2721tu-q% | 15 |
| umtxumfyj. | |
| Blowing Agent | |
| Water | 0.8 |
| 1233zd(E) | As described in Table C1B below |
| Total Polyol Premix (less 1233zd(E)) | 120.2 |
| MDI | 203.7 |

Five foamable compositions were made according to Table C1 above using the amounts of 1233zd(E) and combinations of 1233ad(E) and cyclopentane as indicated in Table C1B below:

TABLE C1B

| | Polyol | Blowing Agent | | |
|---|---|---|---|---|
| | | Component | Mol% of | PPHP |
| | | | Blowing Agent | |
| Foams | | | | |
| ExC1A | A | 1233zd(E) | 100 | 38.5 |
| ExC1B | A | 1233zd(E) | 100 | 43.4 |
| ExC1C | A | 1233zd(E) | 100 | 48.1 |
| ExC1D | A | 1233zd(E) | 100 | 52.9 |
| ExC1E | A | 1233zd(E) | 100 | 57.7 |
| ExC2A | D | 1233zd(E) | 100 | 45 |
| ExC2B | D | 1233zd(E) | 100 | 60 |
| ExC2C | D | 1233zd(E) | 100 | 75 |
| ExC2D | D | 1233zd(E) | 50 | 45 |
| | | Cyclopentane | 50 | |
| ExC2E | D | 1233zd(E) | 50 | 60 |
| | | Cyclopentane | 50 | |
| ExC2F | D | 1233zd(E) | 50 | 75 |
| | | Cyclopentane | 50 | |

For each of the foamable compositions Ex C1A-ExC2F, a foam was produced by hand mixing the polyol premix at a temperature of 50-62.5° F. with the MDI at about 71.5° F. in either a 12″×12″×5″ open top mold or a 14″×14″×4″ open top mold.

The reactivity of each foam and the properties of the foam thus produced are reported in Tables C1C1 and C1C2 below:

TABLE C1C1
Polyol A

| | | | | | |
|---|---|---|---|---|---|
| Example > | ExC1A | ExC1B | ExC1C | ExC1D | ExC1E |
| Reactivity | | | | | |
| Cream | 9 | 9 | 9 | 9 | 9 |
| Time, sec. | | | | | |
| Gel Time, sec. | 40 | 40 | 43 | 44 | 55 |
| Example > | ExC1A | ExC1B | ExC1C | ExC1D | ExC1E |
| Tack Free | 95 | 93 | 116 | 107 | 97 |
| Time, sec. | | | | | |
| Foam | | | | | |
| Properties | | | | | |
| Density | 31.4 | 29.3 | 27.7 | 25.6 | 24.7 |
| (kg/m³) | | | | | |
| Initial K-factor | 17-17.5 | 17-17.5 | 17-17.5 | 17-17.5 | 17 - 17.5 |
| (mW/mK) | | | | | |
| (Est. for | | | | | |
| commercial | | | | | |
| foaming) | | | | | |
| Delta lamda | 6.50 | 6.50 | 6.63 | 6.63 | 6.40 |
| Dim-Vac | 1.92 | 1.42 | 2.55 | 2.98 | 3.02 |
| (Hot), % | | | | | |
| volume | | | | | |
| change | | | | | |
| Dim-Vac | 0.73 | 1.44 | 1.23 | -43.87 | -45.55 |
| (Cold), % | | | | | |
| volume | | | | | |
| change | | | | | |

| | |
|---|---|
| TABLE | C1C2- Polyol D |

| | | | | | | |
|---|---|---|---|---|---|---|
| Example > | Ex C2A | Ex C2B | Ex C2C | Ex C2D | Ex C2E | Ex C2F |
| Reactivity | | | | | | |
| Cream | 15 | 15 | 14 | 15 | 15 | 14 |
| Time, sec. | | | | | | |
| Gel Time, sec. | 61 | 65 | 76 | 60 | 65 | 68 |
| Tack Free | 310 | 315 | 280 | 240 | 245 | 245 |
| Time, sec. | | | | | | |
| Foam | | | | | | |
| Properties | | | | | | |
| Density | 33.6 | 27.84 | 24.16 | 33.28 | 27.68 | 24.16 |
| (kg/m³) | | | | | | |
| Initial K-factor | 19.1 | 19.6 | 20.5 | 20.2 | 20.6 | 21.9 |
| (mW/mK) | | | | | | |
| (Est. for | | | | | | |
| commercial | | | | | | |
| foaming) | | | | | | |
| Delta lamda | | | | | | |
| Dim-Vac | 0.61 | 2.24 | 3.7 | 1.18 | 2.37 | 4.71 |
| (Hot), % | | | | | | |
| volume | | | | | | |
| change | | | | | | |
| Dim-Vac | 1.43 | 2.66 | -45.08 | 1.58 | 2.61 | -31.22 |
| (Cold), % | | | | | | |
| volume | | | | | | |
| change | | | | | | |

The Dim-Vac test, which measures the dimensional stability of foam samples over time as they are exposed to vacuum and aging conditions, was determined using the following procedure. Six (6) samples of each foam were cut to the dimensions of 4″×4″×1″, with three samples being used for the testing conditions denoted as “hot” and three samples for testing conditions denoted as “cold.” Samples edges should be smooth, uniform, and free of cracks. The sample should have no layers. Samples were conditioned to a constant mass in a 23±2° C. and 50±10% relative humidity environment before being exposed to vacuum and the specific aging conditions. After making the foams, conditioning them for the proper amount of time, and cutting the samples, each sample is positioned in an appropriate device for accurately measuring the dimensions of the sample prior to the testing condition parameters being conducted. The three testing conditions used are:

| Condition | Temperature °C (°F) | Relative Humidity % |
|---|---|---|
| Vacuum Oven | 70 ±2 (158 ±4) | Ambient |
| Cold | -29 ±2 (-20.2 ±4) | Ambient |
| Hot & Humid | 70 ±2 (158 ±4) | 97 ± 3% |

The Vacuum Oven step was equilibrated to the conditions identified above at a pressure of 7 mtorr absolute. After 48 hours+/−1 hour at 70° C. and 7 mtorr vacuum, the vacuum and heat are discontinued, and the samples are removed and then tested at room temperature and pressure for weight and dimensional condition using the same procedures used prior to conditioning in the oven. For the “cold” test, three of the samples are then placed in a freezer maintained at the temperature identified in the table above for 24 hours. For the “hot” test, three of the samples are then placed in an oven maintained at the temperature and humidity identified in the table above for 24 hours. All six samples were then removed from the respective chambers and allowed to equilibrate for 2 hours, and the weight and dimensions are again measured. Volume change is then determined using the following calculations:

$$\% Change = \frac{( {V}_{f} - {V}_{i} )}{{V}_{i}} \times 100$$

Where:
V_{f}=Final volume measurement
Vᵢ=Initial volume measurement
Initial Volume is determined using the following equation:

Vᵢ=Lᵢ×W_{L}×Hᵢ
Where:
Lᵢ=Initial length
Wᵢ=Initial width
Hᵢ=Initial average height
Conditioned Volume is determined using the following equation:

V_{f}=L_{f}×W_{f}×H_{f}
Where:
L_{f}=Length after conditioning
W_{f}=Width after conditioning
H_{f}=Average height after conditioning

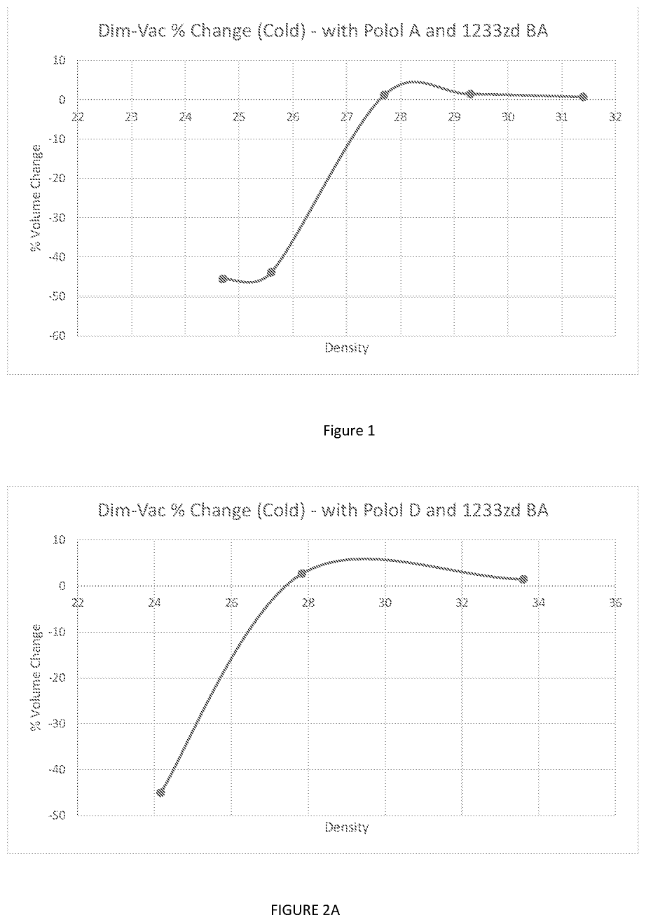

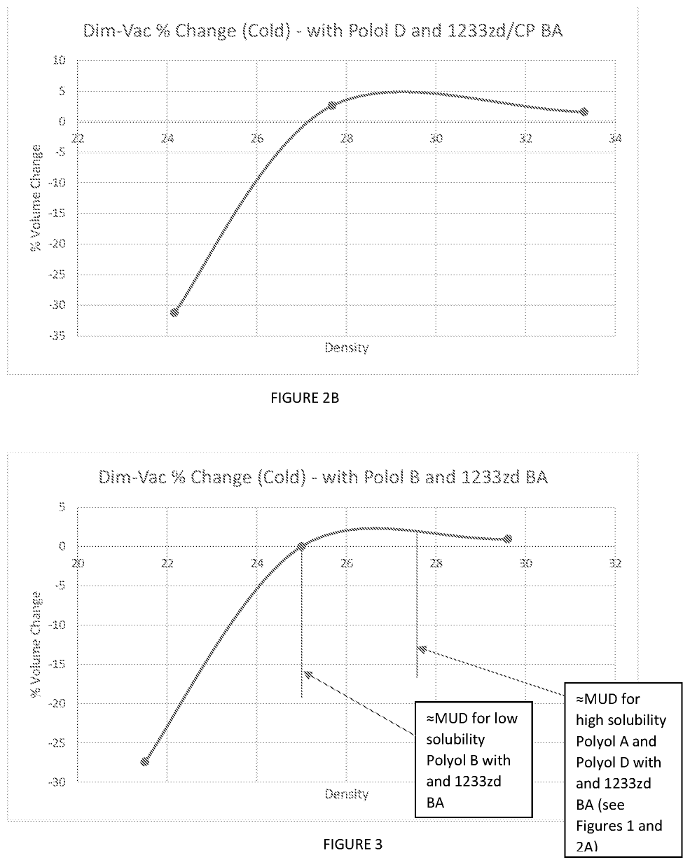

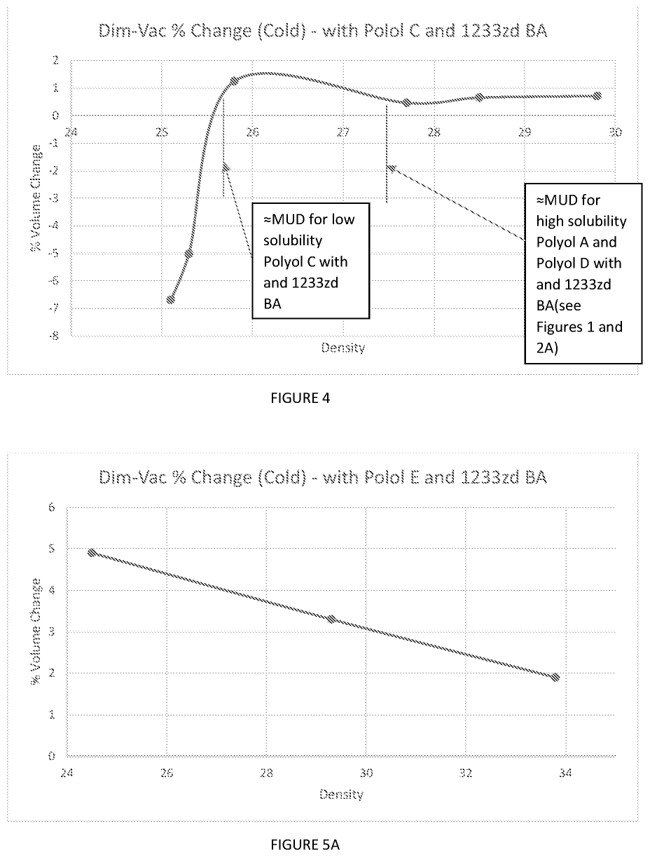

Each of the Dim-Vac (cold) results as determined by this technique are illustrated in FIGS. 1, 2A and 2B hereof.

As can be seen from the data above and as illustrated in FIGS. 1, 2A and 2B, the use of polyols having a 1233zd(E) solubility of greater than 20 pphp to make a PIR foam, while capable of making a foam with good thermal insulating properties, results in a minimum useable density of about 27.5 kg/m³, with a similar result occurring when the blowing agent comprises 50:50 mole ratio of 1233zd(E) and cyclopentane. These are undesirable results for many applications. By way of comparison, the use of mixture consisting of cyclopentane and isopentane in this formulation produces a MUD of about 25 kg/m³. This difference discourages the use more environmentally friendly, and non-flammable, 1233zd(E) as a blowing agent in such applications and/or undesirably would cause a weight or cost penalty when 1233zd(E) is used in such applications.

### Examples 1-4: Foams Made with Polyols Having Low 1233zd(E) Solubility for Polyols

The materials and procedures described in Comparative Example 1 were repeated except that low solubility polyols Polyol B, Polyol C and Polyol E were used instead of the high solubility in the Comparative Examples, and except as indicated in Tables E1/2 and E3/4 below¹. The results for Polyol B and Polyol C are provided in Table E1/2 below and the results for Polyol E are provided in Tables E2/3: ¹ The modifications in catalyst and MDI were made in order to make the reactivity of the foaming procedure comparable to the results in Comparative Example 1.

TABLE E1
/2*

| Example | E1A | E1B | Ex1 | Ex2 | Ex2 | Ex2 | Ex2D | Ex2E | EX2 | EX2G |
|---|---|---|---|---|---|---|---|---|---|---|
| > | | | c | A | B | c | | | F | |
| Polyol | B | | | C | | | | | | |
| Cat K15, | NC | NC | NC | 2.3 | 2.3 | 2.3 | 2.3 | 2.3 | 2.3 | 2.3 |
| pphp | | | | | | | | | | |
| Cat | 1.0 | 1.0 | 1.0 | 1.1 | 1.1 | 1.1 | 1.1 | 1.1 | 1.1 | 1.1 |
| PC8,pphp | | | | | | | | | | |
| 1233zd(E) | 38.6 | 53.1 | 67.6 | 38.9 | 43.7 | 48.6 | 53.5 | 53.5 | 58.3 | 58.3 |
| amount, | | | | | | | | | | |
| PPhp | | | | | | | | | | |
| MDI | 217.2 | 217.2 | 217.2 | 218.8 | 218.8 | 218.8 | 218.8 | 218.8 | 218.8 | 218.8 |
| Example | E1A | E1B | Ex1 | Ex2 | Ex2 | Ex2 | Ex2D | Ex2E | EX2 | EX2G |
| > | | | C | A | B | c | | | F | |
| Polyol | B | | | C | | | | | | |
| Reactivit | | | | | | | | | | |
| y | | | | | | | | | | |
| Cream | 10 | 10 | 10 | 8 | 8 | 7 | 7 | 9 | 8 | 8 |
| Time, sec. | | | | | | | | | | |
| Gel Time, | 49 | 49 | 49 | 45 | 45 | 48 | 30 | 48 | 46 | 46 |
| sec. | | | | | | | | | | |
| Tack Free | 98 | 85 | 92 | 55 | 55 | 56 | 52 | 56 | 56 | 56 |
| Time, sec. | | | | | | | | | | |
| Foam | | | | | | | | | | |
| Propertie | | | | | | | | | | |
| s | | | | | | | | | | |
| Density | 29.6 | 25.0 | 21.5 | 29.8 | 28.5 | 27.7 | 25.8 | 25.3 | 25.1 | 22.2 |
| (kg/m³) | | | | | | | | | | |
| Initial K- | 16- | 16- | 16- | 17- | 17- | 17- | 17- | 17- | 17- | 17- |
| factor | 16.5 | 16.5 | 16.5 | 17.5. | 17.5. | 17.5. | 17.5. | 17.5. | 17.5. | 17.5. |
| (mW/mK) | | | | | | | | | | |
| (Est. for | | | | | | | | | | |
| com merci | | | | | | | | | | |
| al | | | | | | | | | | |
| foaming) | | | | | | | | | | |
| Delta | 5.14 | 5.26 | 5.25 | 5.68 | 5.61 | 5.51 | 5.87 | 5.64 | 5.57 | <6 |
| lambda | | | | | | | | | | |
| Example | E1A | E1B | Ex1 | Ex2 | Ex2 | Ex2 | Ex2D | Ex2E | EX2 | EX2G |
| > | | | c | A | B | c | | | F | |
| Polyol | B | | | C | | | | | | |
| Dim-Vac | 0.94 | 1.61 | -27.4 | 0.71 | 0.65 | 0.46 | 1.25 | -5.02 | -6.69 | -20.0 |
| (Cold), % | | | | | | | | | | |
| volume | | | | | | | | | | |
| change | | | | | | | | | | |
| Dim-Vac | 1.41 | 2.61 | 3.92 | 0.50 | 0.83 | 0.92 | 2.31 | 1.44 | 1.50 | 0-2 |
| (Hot), % | | | | | | | | | | |
| volume | | | | | | | | | | |
| change | | | | | | | | | | |

• NC - no change

TABLE E3
/4*

| Example | | Ex3A | Ex3B | Ex3D | Ex4A | Ex4B | EX4C |
|---|---|---|---|---|---|---|---|
| > | | | | | | | |
| Polyol | | E | | | | | |
| Cat K15, | | 1.6 | 1.6 | 1.6 | 1.6 | 1.6 | 1.6 |
| pphp | | | | | | | |
| Cat | | 1.0 | 1.0 | 1.0 | 1.0 | 1.0 | 1.0 |
| PC8,pphp | | | | | | | |
| Total | 100% | 33.6 | 27.8 | 24.2 | | | |
| Agent | 1233zd(E) | | | | | | |
| amount, | | | | | | | |
| PPhp | | | | | | | |
| Blowing | 70 wt.% | | | | 33.3 | 26.7 | 24.2 |
| | 1233zd(E) | | | | | | |
| Example | | Ex3A | Ex3B | Ex3D | Ex4A | Ex4B | EX4C |
| > | | | | | | | |
| Polyol | | E | | | | | |
| | 30 wt.% | | | | | | |
| | cyclopentane | | | | | | |
| MDI | | 217.2 | 217.2 | 217.2 | 217.2 | 217.2 | 217.2 |
| Reactivity | | | | | | | |
| Cream | | 15 | 14 | 15 | 17 | 18 | 15 |
| Time, sec. | | | | | | | |
| Gel Time, | | 63 | 65 | 65 | 70 | 73 | 61 |
| sec. | | | | | | | |
| Tack Free | | 240 | 185 | 195 | 232 | 240 | 310 |
| Time, sec. | | | | | | | |
| Foam | | | | | | | |
| Properties | | | | | | | |
| Density | | 33.8 | 29.3 | 24.5 | 31.6 | 27.4 | 23.8 |
| (kg/m³) | | | | | | | |
| Initial K- | | 18.4 | 18.9 | 19.9 | 19.5 | 20.2 | 21.6 |
| factor | | | | | | | |
| (mW/mK) | | | | | | | |
| (Est. for | | | | | | | |
| commercia | | | | | | | |
| 1 foaming) | | | | | | | |
| Delta | | A* | A* | A* | A* | A* | A* |
| lambda | | | | | | | |
| Dim-Vac | | 1.9 | 3.3 | 4.9 | 2.2 | 3.3 | 3.07 |
| (Cold), % | | | | | | | |
| volume | | | | | | | |
| change | | | | | | | |
| Dim-Vac | | 2.1 | 3.2 | 3.9 | 2.0 | 3.4 | 6.0 |
| (Hot), % | | | | | | | |
| Example | | Ex3A | Ex3B | Ex3D | Ex4A | Ex4B | EX4C |
| > | | | | | | | |
| Polyol | | E | | | | | |
| volume | | | | | | | |
| change | | | | | | | |

* Considered to be acceptable but not quantified

The Dim-Vac results for Examples 1-4 are illustrated in FIGS. 3-5B hereof. In this regard it is noted that a 50:50 mole blend of 1233zd(E) and cyclopentane is the same as a 70:30 weight blend, and therefore the results for Comparative Example ExC2D, ExC2F use the same blowing agent as Examples Ex4A-Ex4C.

As can be seen from the data reported above, as illustrated in the Figures hereof, selection of the polyol component to have a 1233zd(E) solubility of about 20 pphp or less results in a dramatic and unexpected improvement in the important foam property of minimum useable density (MUD) when the blowing agent comprises 1233zd(E). For example, while the low solubility polyols A and D have a MUD of about 27.5, as shown in FIGS. 3 and 4 Polyols B and C have a MUD of approximately 25 and about 25.5, respectively. This is a surprising and highly advantageous result. The results for Polyol E with 1233zd(E) is even more dramatically unexpected. In particular, as shown in FIG. 5A, this foam has a volume change that has not even begun to decrease at the lowest tested density of 24.5, thus establishing that the MUD for this foam is below 24.5.

### Example 5—Foams Made with Polyols Having Low 1233zd(E) Solubility for Polyols and Blowing Agent Comprising 1233zd(E) and Cyclopentane

The materials and procedures described in Example 1 were repeated for the Polyol B expect that the physical blowing agent tested included blends of 1233zd(E) with cyclopentane. In addition, foam was made using the same procedure using 100% 1233zd(E) as the physical blowing agent, and for comparison purposes a blend of cyclopentane and isopentane was also tested. The results are reported in Table E5 below²: ² The modifications in catalyst and MDI were made in order to make the reactivity of the foaming procedure comparable to the results in Comparative Example 1.

TABLE E5
*

| | | | | |
|---|---|---|---|---|
| Example | E5A | E5B | E5C | E5D |
| > | | | | |
| Cat | 1.0 | 1.0 | 1.0 | 1.0 |
| PC8,pphp | | | | |
| 1233zd(E) | 39.7 | 19.2 | 19.2 | 0 |
| amount, | | | | |
| pphp | | | | |
| Cyclopen | 0 | 9.6 | 12.0 | 13.5 |
| tane | | | | |
| amount, | | | | |
| PPhp | | | | |
| Wt. Ratio | NA | 68:32 | 61:39 | NA |
| 1233zd(E) | | | | |
| xyclopen | | | | |
| tane | | | | |
| Isopenta | 0 | 0 | 0 | 5.8 |
| ne | | | | |
| MDI | 217.2 | 217.2 | 217.2 | 217.2 |
| Reactivit | | | | |
| y | | | | |

| | | | | |
|---|---|---|---|---|
| Example | E5A | E5B | E5C | E5D |
| > | | | | |
| Cream | 10 | 10 | 10 | 10 |
| Time, sec. | | | | |
| Gel Time, | 49 | 49 | 49? | 49 |
| sec. | | | | |
| Foam | | | | |
| Propertie | | | | |
| s | | | | |
| Initial K- | 16.36 | 17.26 | 17.61 | 19.69 |
| factor | | | | |
| (mW/mK) | | | | |
| (Est. for | | | | |
| com merci | | | | |
| al | | | | |
| foaming) | | | | |
| Delta | 4.04 | 4.21 | 4.88 | 5.08 |
| lambda | | | | |

• NC - no change

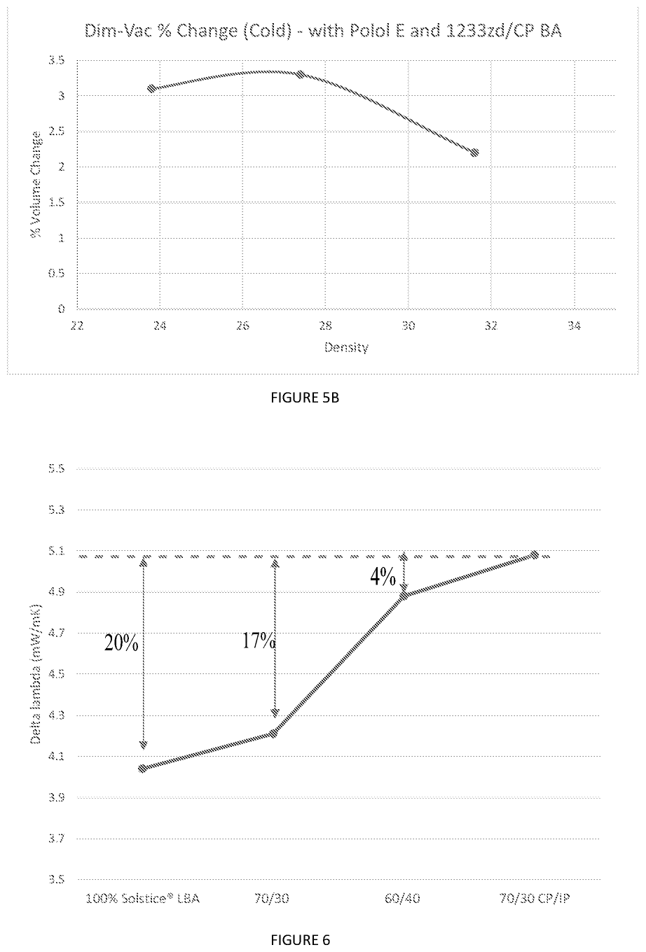

For convenience, these results are illustrated in the graph in FIG. 6.

As can be seen from the results reported in this example, the delta lambda is unexpectedly low when the physical blowing agent comprises greater than about 60% by weight of 1233zd(E) and less than about 40% by weight of cyclopentane. In particular, applicants have found that while the use of an approximate 60/40 blend of 1233zd(E)/cyclopentane produces less than a 5% relative improvement in Delta Lambda, increasing the relative amount to greater than about 60% produces a dramatically larger, and unexpected, improvement in Delta Lambda. Moreover, this improvement levels off at amounts of 1233zd(E) above about 70% of 1233zd(E). Accordingly, the preferred blowing agent blends of the present invention, including particularly Blowing Agent 5 and 6, are able to achieve an unexpected advantage in both performance and cost.

1. A method of producing thermosetting PU and/or PIR foams comprising:
(a) providing a polyol premix composition comprising a blowing agent comprising at least about 50% by weight of trans-1-chloro-3,3,3-trifluoropropene (1233zd(E)) and one or more polyol components that together have a sufficiently low solubility limit for said 1233zd(E) to permit foams made from said premix to have a minimum usable density (“MUD”) of less than 27 kg/m³; and
(b) combining said polyol premix composition with a polyisocyanate to form a foamable composition; and
(c) foaming said foamable composition and producing a foam having a MUD of less than 27 kg/m³.

2. The method of claim 1 wherein said one or more polyols comprises at least about 50% by weight of polyester polyol.

3. The method of claim 1 wherein said one or more polyols comprises at least about 75% by weight of polyester polyol.

4. The method of claim 3 wherein said one or more polyols comprises at least about 80% by weight of polyester polyol.

5. The method of claim 1 wherein said foam has MUD of less than 26 kg/m³.

6. The method of claim 5 wherein said foam has MUD of less than 26 kg/m³.

7. The method of claim 1 wherein said foam has MUD of less than 25 kg/m³.

8. The method of claim 5 wherein said foam has MUD of less than 25 kg/m³.

9. A method for producing thermosetting PU and/or PIR foams with good thermal insulating properties and low minimum usable density (MUD), said method comprising:
(a) providing a polyol premix composition comprising one or more polyols and a blowing agent comprising trans-1-chloro-3,3,3-trifluoropropene (1233zd(E)), wherein said one or more polyols comprises at least about 50% by weight of a polyol having a 1233zd(E) solubility of about 20 pphp or less; and
(b) combining said polyol premix composition with a polyisocyanate to form a foamable composition; and
(c) foaming said foamable composition and producing a foam having a minimum usable density (“MUD”) of less than 27 kg/m³.

10. The method of claim 9 wherein said one or more polyols comprises at least about 75% by weight of a polyol having a 1233zd(E) solubility of less than about 15 pphp.

11. A thermosetting PU and/or PIR foam with good thermal insulating properties and low minimum density, said foams comprising:
(a) cell walls formed of PU and/or PIR forming a plurality of closed cells; and
(b) 1233zd(E) contained in said cell walls,
wherein said foam has a MUD of less than 27 kg/m³, an initial K-factor of 18 mW/mK or less, and a Delta lambda of less than 6.

12. The foam of claim 11 wherein said foam is a PU foam.

13. The foam of claim 11 wherein said foam is a PIR foam.

14. The foam of claim 11 wherein said MUD is less than 25 kg/m3.

15. A board comprising the foam of claim 11.

16. A slab comprising the foam of claim 11.

17. A pour-in-place panel comprising the foam of claim 11.

18. A building structure comprising a board according to claim 17.

19. A building structure comprising a slab according to claim 17.

20. The method of claim 9 wherein said one or more polyol components together have a sufficiently low solubility limit for said blowing agent to permit foams made from said premix to have a MUD of less than 27 kg/m³.
